(19) United States
(12) Patent Application Publication
(10) Pub. No.: US 2014/0308595 A1
(43) Pub. Date: Oct. 16, 2014

(54) Fuel Cell System

(71) Applicants: Thomas Baur, Weilheim (DE); Matthias Jesse, Dettingen (DE); Cyrill Lohri, Braunschweig (DE); Cosimo Mazzotta, Ulm (DE); Holger Richter, Kirchheim (DE); Klaus Scherrbacher, Deggingen (DE); Christian Schick, Wendlingen (DE)

(72) Inventors: Thomas Baur, Weilheim (DE); Matthias Jesse, Dettingen (DE); Cyrill Lohri, Braunschweig (DE); Cosimo Mazzotta, Ulm (DE); Holger Richter, Kirchheim (DE); Klaus Scherrbacher, Deggingen (DE); Christian Schick, Wendlingen (DE)

(73) Assignee: Daimler AG, Stuttgart (DE)

(21) Appl. No.: 14/237,122

(22) PCT Filed: Jul. 21, 2012
(86) PCT No.: PCT/EP2012/003088

§ 371 Date: May 30, 2014

(30) Foreign Application Priority Data
Aug. 5, 2011 (DE) 10 2011 109 602.0

(51) Int. Cl. H01M 8/04

(52) U.S. Cl. CPC H01M 8/04164
USPC 429/413

(57) ABSTRACT

A fuel cell system includes at least one fuel cell, line elements for supplying and discharging starting materials and/or products to/from the fuel cell, and at least one condensation unit. The condensation unit is situated in at least one of the line elements and, at least in individual operating phases of the fuel cell, the condensation unit is at a lower temperature level than the areas surrounding it and the fuel cell.

### BACKGROUND AND SUMMARY OF THE INVENTION

Exemplary embodiments of the invention relate to a fuel cell system.

Fuel cell systems are known from the general prior art. They are typically used to provide electrical power from supplied starting materials such as hydrogen and oxygen. Such fuel cells are frequently designed as so-called PEM fuel cells, and have a membrane separating a cathode chamber that is supplied with oxygen from an anode chamber that is supplied with hydrogen. During operation, in addition to the electrical power, product water that is partly in gaseous form and partly in liquid form results, which is discharged from the fuel cell via the exhaust gases. In particular, when a so-called PEM fuel cell is used, it is also known and customary to appropriately humidify the starting materials supplied to the fuel cell, or at least one of the starting materials, typically the oxygen or the air that is used as the oxygen supplier. Thus, during operation, gases loaded with liquid, and in particular water in the vaporous state, are present in the region of the supply lines as well as the discharge lines to/from the fuel cell.

When such a fuel cell system is used under varying environmental conditions, for example in a motor vehicle, it is absolutely necessary that the fuel cell system is able to start, even at temperatures below the freezing point. However, when such a fuel cell system is switched off at its operating temperature, water vapor remains in the area of the fuel cell itself and at least in the area of the line elements for supplying and discharging starting materials/products to/from the fuel cell. The water vapor that is bound in the moist gas then condenses out at temperatures below the dew point. The condensation takes place in an undirected manner. That is, the condensation begins at the location in the fuel cell system where the temperature first drops below the dew point, and spreads in the fuel cell system. A comparatively large reservoir of water vapor is present in particular in the fuel cell itself, so that in this case as well, as the fuel cell system cools over time from the operating temperature to a standstill temperature, a comparatively large amount of water vapor condenses out, and liquid water is present and deposits at the coldest locations.

The problem is that this liquid water may freeze at ambient temperatures below the freezing point. Functionally relevant components, in particular line cross sections, gas channels, and the like thus become clogged with ice, so that restarting the fuel cell system is impossible, or possible only with a significant expenditure of energy and considerable loss of time.

To eliminate this problem, German Unexamined Patent Application DE 10 2006 047 574 A1 discloses a line element for a fuel cell system provided on the inner walls of the flow passages with a nonwoven fabric that absorbs liquid and correspondingly disperses it in the nonwoven fabric due to the capillary effect. Although the problem of freezing is not prevented in this way, the location at which the water freezes is shifted into the region of the nonwoven fabric. When this freezing is shifted solely along the walls, this may result, in particular for use in a line element, in at least a certain flow cross section of the line element remaining open, even when there is frozen water, thus enabling operation and in particular start-up of the fuel cell system even under these adverse conditions.

An alternative approach in this regard is taken in Japanese patent document JP 2003-151601 A, for example. The English abstract of the Japanese patent specification states that when a fuel cell system is switched off, the cooling of the fuel cell is reduced and therefore the fuel cell itself heats up. The condensation of water in the region of the fuel cell, which is then comparatively hot with respect to the remainder of the system, is thus prevented, and the water preferentially condenses in the region of the peripheral components surrounding the fuel cell, since the temperature first drops below the dew point at that location.

The procedure of heating critical components during switching-off of the fuel cell system has the significant drawback that it is comparatively energy-intensive. In addition, the heating of the fuel cell may very easily result in damage to the membranes, thus disadvantageously reducing the service life of a fuel cell.

Exemplary embodiments of the present invention avoid these disadvantages by using a fuel cell system designed in such a way that it is able to reliably prevent freezing of important components of the fuel cell system in an energy-efficient manner.

The fuel cell system according to the invention includes a condensation unit situated in at least one of the line elements for supplying and discharging starting materials and/or products to/from the fuel cell, the condensation unit, at least in individual operating phases of the fuel cell, being at a lower temperature level than the areas surrounding it and the fuel cell. Such a condensation unit may be inserted into the line elements at an appropriate location in order to intentionally select a location at which the temperature first drops below the dew point in the critical phases of the system cooling. This may be achieved, for example, by active cooling or also by passive cooling, for example in that elements of the condensation unit are not insulated, while thermal insulation is applied in the surrounding areas. An area is then intentionally created in the region of the condensation unit in which the dew point first reaches a value necessary for condensation. Instead of the undirected condensation of water at an arbitrary location within the fuel cell system that cannot be influenced, this results in targeted condensation in the region of the condensation unit. The condensation unit may be designed in such a way that it is not plugged by condensed, possibly freezing, water, for example in that the condensation unit has a sufficient installation size or a sufficient installation volume in order to divert the water downwardly in the direction of the force of gravity, for example, and to allow the water to freeze in an area in which no clogging of the line element is to be expected. When the targeted condensation begins in the region of the condensation unit, the water vapor from the surrounding areas also passes into this region and condenses there, thus securely and reliably preventing undesirable condensation in components and areas in which this is not desired, in particular in the region of the fuel cell and in the region of the conveying units for the starting materials and/or products. Freezing of critical parts and components of the fuel cell system is thus prevented without having to expend additional energy for heating the critical components.

In one particularly favorable and advantageous refinement of the fuel cell system according to the invention, the condensation unit has built-in components that enlarge the inner surface. Such built-in components may be, for example, mesh, fabric, foams, or the like. These materials enlarge the inner surface, which in the corresponding operating phases is cooler than the surroundings, and thus provide a large surface area for the condensation of water vapor in the region of the condensation unit. When sponges or nonwoven fabrics, for example, are used for enlarging the surface, they would be able to absorb condensed water due to the capillary effect in the manner known from the above-cited German Unexamined Patent Application, and thus securely and reliably prevent freezing of necessary flow cross sections, with a small installation size of the condensation unit.

The design of the fuel cell system according to the invention is particularly well suited for use in fuel cell systems that at least occasionally must be switched off and restarted at temperatures below the freezing point. This is the case in particular for fuel cell systems in vehicles. Thus, a particularly favorable and advantageous use of the fuel cell system according to the invention lies in the use of such a fuel cell system in a vehicle.

### BRIEF DESCRIPTION OF THE DRAWING FIGURES

Further advantageous embodiments of the fuel cell system according to the invention are made clear based on the exemplary embodiment which is explained in greater detail below with reference to the figures, which show the following:

FIG. 1 shows a schematically indicated fuel cell vehicle;

FIG. 2 shows a fuel cell system in one possible embodiment according to the invention; and

FIG. 3 shows a schematic illustration of the basic principle according to the invention.

### DETAILED DESCRIPTION

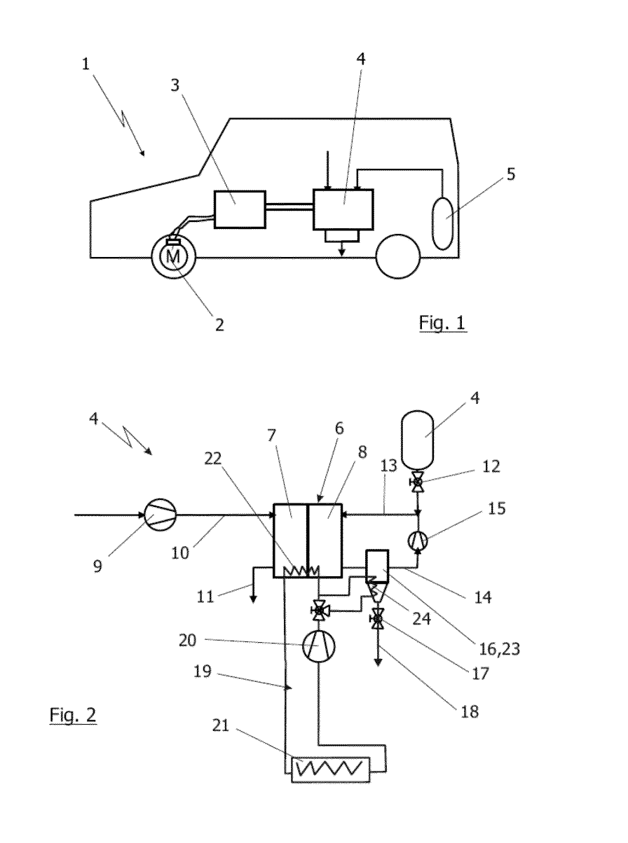

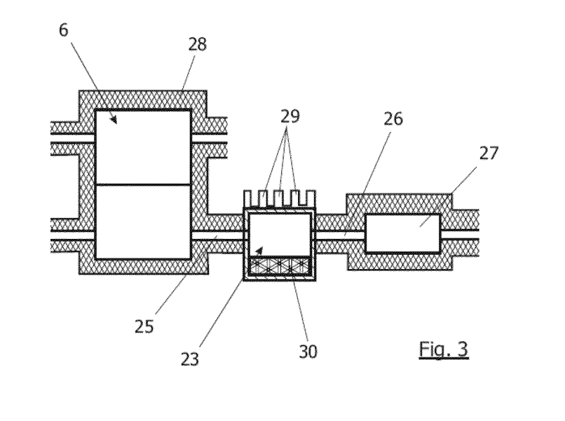

The illustration in FIG. 1 shows a vehicle 1. This schematically indicated vehicle 1 is designed to be driven via an electric motor 2 by way of example, which is indicated in the region of the wheels, and which via a power electronics system 3 is supplied with electrical power from a fuel cell of a fuel cell system 4 indicated overall by a box. In addition, an energy store in the form of a battery, for example (not illustrated), may be present which is likewise controlled via the power electronics system 3 and which in particular may be used for accepting and delivering regenerated braking energy. Air and hydrogen are supplied to the fuel cell system 4 in a known manner for generating the required electrical power. The hydrogen originates from one or more compressed gas stores 5, optionally distributed over the vehicle 1, of which one compressed gas store is illustrated here by way of example. The fuel cell system 4 is described in greater detail in the illustration in FIG. 2. The core of the fuel cell system 4 is a fuel cell 6 that includes a cathode chamber 7 and an anode chamber 8 that are separated from one another by a proton-conductive membrane (PEM). By means of an air conveying unit 9, the cathode chamber 7 is supplied via a supply line 10 with filtered fresh air as the oxygen supplier. The exhaust air passes through an exhaust air line 11 from the cathode chamber 7 of the fuel cell 6. The exhaust air line 11 may lead directly to the environment, into a catalytic burner, and/or into the surroundings of the vehicle 1 via a turbine for recovering pressure energy and/or thermal energy.

As mentioned above, hydrogen from the compressed gas store 5 is supplied to the anode chamber 8 of the fuel cell 6. For this purpose, the hydrogen, which is stored under high pressure in the compressed gas store 5, is metered and depressurized via a valve unit 12, and passes via a hydrogen supply line 13 into the region of the anode chamber 8. Unconsumed hydrogen together with the product water that results in the region of the anode chamber 8 then passes from the anode chamber 8 via a recirculation line 14, and together with fresh hydrogen from the compressed gas store 5 is returned to the region of the anode chamber 8 via a recirculation blower or some other type of recirculation conveying unit 15. The recirculation conveying unit 15 may be designed as a blower and/or as a gas jet pump. It would also be conceivable to operate the anode chamber 8 of the fuel cell 6 in such a way that no, or only minimal, excess exhaust gas results, which could then undergo post-combustion or be discharged directly into the region of the catalytic component.

In the exemplary embodiment described here, having a so-called anode loop with a recirculation line 14 and the hydrogen supply line 13 as well as a recirculation unit 15, it is necessary to occasionally blow off gas from the anode loop in order to be able to maintain the hydrogen concentration in the region of the anode loop at a high level. This is known per se and customary. To this end, a valve unit 17 and a discharge line 18 are indicated in the region of a water separator 16 by way of example.

The illustration in FIG. 2 also shows a cooling circuit 19 in which a liquid coolant is circulated by a coolant conveying unit 20. The cooling circuit 19, which is illustrated here in highly simplified form, has at least one cooling heat exchanger 21 for dissipating the absorbed heat of the cooling medium to the environment. In addition, the cooling circuit has a heat exchanger 22 via which the waste heat which develops in the fuel cell 6 is delivered to the cooling medium. The cooling circuit 19 is thus used primarily to cool the fuel cell 6.

The fuel cell system 4 cools when the vehicle 1 is switched off after driving. Water vapor bound in the gases is present in the region of the fuel cell 6 itself as well as in the region of the line elements 10, 11 and in particular in the region of the line elements 13, 14, and in all other components which are in contact with moist gas. The condensation of the water vapor present in the lines 10, 11, 13, 14 and in the fuel cell 6 as well as in all other components themselves begins as soon as the temperature drops below the dew point in the cooling phase of the fuel cell system 4. This condensation typically takes place in a completely undirected manner. This means that the condensation begins and takes place primarily at the point in the fuel cell system 4 at which the temperature first drops below the dew point.

Thus, the fuel cell 6 itself has a comparatively large reservoir of water vapor evaporating therefrom and migrating through the fuel cell system 4 due to diffusion and convection effects. To prevent this water from now condensing out anywhere in the fuel cell system 4, freezing at that location, and then resulting in problems upon restarting the fuel cell system 4, in the fuel cell system 4 illustrated here a condensation unit 23 is placed in at least one of the line elements 10, 11, 13, 14. In the exemplary embodiment illustrated in FIG. 2, the condensation unit 23 has a design that is integrated into the region of the water separator 16. The condensation unit is positioned in the fuel cell system 4 in such a way that it is situated adjacent to the anode chamber 8 of the fuel cell 6 and is thus suitable for inducing condensation of all or a large part of the moisture occurring in the region of the fuel cell 6. To allow targeted condensation in the region of the condensation unit 23, in the exemplary embodiment illustrated here the condensation unit is actively cooled. The cooling takes place via a heat exchanger 24 situated in the region of the condensation unit 23 and through which the cooling medium flows after it passes through the cooling heat exchanger 21. The condensation unit 23 is thus cooled to a temperature level that is typically below the temperature of the fuel cell 6 itself, which is regulated by the coolant in the direction of flow of the cooling circuit downstream from the heat exchanger 24. If the temperature in the region of the condensation unit 23 is now lower than in the region of the components surrounding it, i.e., the line elements 14, the recirculation conveying unit 15, and in particular the anode chamber 8 of the fuel cell 6, the temperature first drops below the dew point in the region of the condensation unit 23, resulting in targeted condensation in this region. In the embodiment illustrated here, in which the condensation unit at the same time is a water separator 16, the liquid water may be collected and discharged via the valve 17 and the discharge line 18.

In principle, however, a design of the condensation unit 23 which is also independent of such a water separator and provided at another arbitrary location in the fuel cell system 4 is conceivable. The condensation unit 23, as is apparent from the schematic illustration in FIG. 3, is preferably situated between a component which stores and/or generates water vapor and a component 27 that is critical with respect to freezing, which in the present example is once again the fuel cell 6. The condensation unit 23 is connected to the fuel cell 6 via a line element 25. This may be, for example, one of the line elements 10, 13 for supplying, or one of the line elements 11, 14 for discharging, the starting materials or products. The condensation unit 23 is then connected to a component 27 via a further line element 26. This may typically be a component that is particularly critical with regard to freezing, for example a blower or some other type of conveying device whose functionality would be blocked due to ice.

The condensation unit 23 now prevents the moisture from the region of the fuel cell 6 from passing into the region of the component 27, which is critical with regard to freezing, and from condensing out at that location and subsequently freezing at temperatures below the freezing point. Rather, as a predefined local target for the start of the condensation, the condensation unit 23 ensures that the moisture present in the system segment illustrated in FIG. 3 condenses out in the region of the condensation unit 23. For this purpose the condensation unit 23 may be actively cooled, as indicated by the cooling circuit 19 in the exemplary embodiment in FIG. 2. Additionally or alternatively, it would be conceivable to achieve active cooling in some other way, for example via a Peltier element.

In the exemplary embodiment illustrated in FIG. 3, the situation now is that the condensation unit 23 is passively cooled or brought to a temperature below the temperature of the components surrounding it. This may be achieved, for example, in that thermal insulation 28, which is provided around numerous components of the fuel cell system 4, is interrupted in the region of the condensation unit 23 so that the latter cools more rapidly when the fuel cell system 4 is switched off. This more rapid cooling may also be intensified by cooling ribs 29, which in the exemplary embodiment illustrated here are situated on one side of the condensation unit 23. Additionally or alternatively, of course, it would be possible to achieve thermal coupling between the component 23 and a component which is typically cooler, for example by joining these components together via a shared housing or by means of a material having good thermal conductivity.

Of course, other options for cooling the condensation unit 23 are conceivable and possible. Thus, for example, so-called heat pipes may be used which in the region of the condensation unit 23 absorb heat from the evaporation of a liquid, which condenses out in other areas and drips back into the area in which the heat pipe is connected to the condensation unit 23. In this way as well, heat may be efficiently removed from the region of the condensation unit 23.

Regardless of the measure by means of which heat is dissipated and the condensation unit 23 is actively or passively cooled, the effect of the condensation unit 23 is always that the dew point is first reached and the condensation begins in the region of the condensation unit due to the lower temperature which prevails here. The water vapor then passes from the areas surrounding the condensation unit 23 primarily into the region of the condensation unit 23 via convection and diffusion processes, so that condensation of liquid in the region of the adjacent components, in particular the component 27 which is critical with regard to freezing, and the fuel cell 6 may be largely avoided.

Since the condensation typically begins in the region of the inner surface of the condensation unit 23, it may be advantageous to design this surface to be as large as possible in order to be able to provide the maximum surface area for condensation. This may be achieved, for example, by built-in components which enlarge the inner surface of the condensation unit 23. Such built-in components could be, for example, nonwoven fabrics, lattices, sponges, nets, wire meshes, labyrinths, and microscopic or macroscopic surface structures. In the sectional illustration in FIG. 3, a nonwoven fabric 30 is illustrated by way of example in the lower area of the interior of the condensation unit 23.

A very large surface is available on such a nonwoven fabric 30 or wire mesh, which is preferably made of a rustproof metallic, preferably stainless steel, material, this surface assisting in the condensation of the water vapor in the region of the condensation unit 23. In addition, the nonwoven fabric 30 may largely absorb or draw in the resulting water by means of capillary effects and the surface tension of the water, so that, even if freezing subsequently occurs in the region of the condensation unit 23, this water/ice is largely bound in the region of the nonwoven fabric 30, and causes little or no blockage of the flow cross section in the condensation unit 23.

The individual described measures may be combined in any desired manner. In addition, individual aspects of the cooling and/or of the built-in components inside the condensation unit 23 may of course be dispensed with without impairing the functional principle of the condensation unit 23.

If the condensate occurring in the region of the condensation unit 23 cannot be discharged when the fuel cell system 4 is switched off, as is possible in the exemplary embodiment according to FIG. 2, for example, the condensate may also be stored in an appropriate area of the condensation unit 23. This area is represented by the nonwoven fabric 30 in the illustration in FIG. 3, and is typically less than a flow cross section that is actually needed for flowing through the condensation unit 23. It may thus be ensured that accumulating water and ice that may possibly form therefrom does not block the flow cross section upon restarting. During longer-term operation of the fuel cell system 4, the region of the condensation unit 23 is then reheated until the water evaporates and is also discharged in a manner known per se, for example via the water separator which is present in the system anyway, and/or via the exhaust gas which is discharged from the system.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1-10. (canceled)

11. A fuel cell system, comprising:
at least one fuel cell;
line elements arranged within the system to supply and discharge starting materials or products to/from the fuel cell; and
at least one condensation unit situated in at least one of the line elements, wherein the at least one condensation unit is configured so that, at least in individual operating phases of the fuel cell, the at least one condensation unit is at a lower temperature level than areas surrounding the at least one condensation unit and the fuel cell.

12. The fuel cell system according to claim 11, wherein the at least one condensation unit is arranged within the fuel cell system so that the at least one condensation unit is passively cooled.

13. The fuel cell system according to claim 12, wherein the passive cooling is achieved by including less thermal insulation in a region of the condensation unit compared to the areas surrounding the at least one condensation unit.

14. The fuel cell system according to claim 11, wherein the at least one condensation unit is configured to be actively cooled.

15. The fuel cell system according to claim 14, wherein the active cooling is achieved by a connection of the at least one condensation unit to a cooling circuit of the fuel cell system.

16. The fuel cell system according to claim 11, wherein the at least one condensation unit is integrated into an existing component of the fuel cell system.

17. The fuel cell system according to claim 11, wherein the at least one condensation unit has built-in components providing an enlarged inner surface area compared to an inner surface area of the at least one condensation unit without the built-in components.

18. The fuel cell system according to claim 11, wherein the at least one condensation unit is situated upstream/downstream from the fuel cell or from a conveying device for the starting materials/products.

19. The fuel cell system according to claim 11, wherein the at least one condensation unit is situated between a component that stores or generates water vapor and a component that is critical with respect to freezing.

20. A method for a fuel cell system comprising at least one fuel cell, line elements arranged within the system to supply and discharge starting materials or products to/from the fuel cell, and at least one condensation unit situated in at least one of the line elements, the method comprising:
controlling a temperature of the at least one condensation unit so that, at least in individual operating phases of the fuel cell, the at least one condensation unit is at a lower temperature level than areas surrounding the at least one condensation unit and the fuel cell.

21. The method according to claim 20, wherein the temperature control of the at least one condensation unit is achieved by passively cooling the at least one condensation unit.

22. The method according to claim 20, wherein the temperature control of the at least one condensation unit is achieved by active cooling.

23. The method according to claim 22, wherein the active cooling is achieved by connecting the at least one condensation unit to a cooling circuit of the fuel cell system.
